(19) United States
(12) Patent Application Publication
(10) Pub. No.: US 2018/0357938 A1
(43) Pub. Date: Dec. 13, 2018

(54) Variable Sign Display System and Method

(71) Applicant: James Berry McGregor, St. Thomas (CA)

(72) Inventor: James Berry McGregor, St. Thomas (CA)

(21) Appl. No.: 15/974,359

(22) Filed: May 8, 2018

Related U.S. Application Data
(60) Provisional application No. 62/518,135, filed on Jun. 12, 2017.

(51) Int. Cl. G09F 7/10; G09F 11/30; G09F 7/18; G08B 5/02

(52) U.S. Cl. CPC G09F 7/10; G09F 11/30; G09F 2007/1843; G08B 5/02; G09F 7/18

(57) ABSTRACT

A variable sign display system for displaying one of two selectable messages. The variable sign display may include a housing and a sliding board contained within the housing. The sliding board includes two messages. In use, one of the messages is displayed by laterally sliding the sliding board while the other message is concealed via a front of the housing. The variable sign display is useful for hotel doors or other applications requiring convenient selection of a message to be visibly displayed.

### CROSS-REFERENCE TO RELATED APPLICATION(S)

The present application is related to and claims priority to U.S. Provisional Patent Application No. 62/518,135 filed Jun. 12, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of signage of existing art and more specifically relates to door signs.

### RELATED ART

Signs are used in many instances to purvey information to readers. Signs are any kind of visual graphics created to display information to a particular audience. This is typically manifested in the form of wayfinding or instructional information in places such as streets or on the inside and outside of buildings. Signs vary in form and size based on location and intent, from more expansive banners, billboards, and murals, to smaller street signs, street name signs, sandwich boards and lawn signs. Digital or electronic displays may also be used as signage; however, may be expensive to buy and operate.

The main purpose of signs is to communicate, to convey information such that the receiver may make cognitive decisions based on the information provided. Instructional signs may convey information about services and facilities, such as maps or directories. Other types of signs may be used specifically for directional, identification, or safety purposes. Efficient signage is desirable.

Various attempts have been made to solve problems found in signage art. Among these are found in: U.S. Pat. Nos. 7,378,982, 5,608,979, and 6,236,303. This prior art is representative of door signs.

None of the above inventions and patents, taken either singly or in combination, is seen to describe the invention as claimed. Thus, a need exists for a reliable two-way door sign system, and to avoid the above-mentioned problems.

### SUMMARY OF THE INVENTION

The present invention advantageously fills the aforementioned deficiencies by providing a sign which may be easily and conveniently manipulated between two messages. The present invention is superior to other systems in that it effectively alternates between two messages without disposable or easy-to-loose components.

The present invention includes a sign housing mountable to a door containing a sliding message board which may be manually slid to display one of two messages (alternately, as desired) printed on the message board. The two-way door sign may be constructed in such a way that one of the two messages is concealed by the sign housing at any given time, while the other message is displayed on the front of the sign. The sign may be temporarily or permanently mounted to a door in a prominently visible location, and one of the two messages selected to display the desired message. The message may be selected by sliding the message board left or right within the sign housing. If, for example, a user desires to display a first message, they may slide the message board to the right to reveal the first message. Alternatively, if the user desires to display a second message, they may slide the message board to the left to reveal the second message. When one message is displayed, the other is concealed. The invention is particularly applicable to a hotel door. In one embodiment, the two-way door sign may include messages reading “Please Do Not Disturb” or “Please Make Up Room”. Alternative embodiments may include a variety of message selections and combinations.

A significant advantage of the invention is that it may improve the convenience and appearance of hotel room doors when guests leave directions for housecleaning. The sign may be used to replace disposable paper door knob hangers which may be flipped one way or the other to indicate instructions for housecleaning. The use of the two-way door sign reduces waste from replacing paper door hangers by providing a permanent solution which is not prone to destruction or misplacement. Additionally, the two-way door sign provides a cleaner, more attractive look, which may improve guest satisfaction.

The convenience of the two-way door system may also improve customer service by eliminating confusion between guests and housekeepers when unclear instructions are not left, or when a door hanger is accidentally lost. The use of the two-way door sign, when mounted to a door, reduces clutter and eliminates the risk of loss.

A variable sign display system and method is disclosed herein. The variable sign display may essentially comprise: a housing defined by a front, a back, four sides, and an interior volume; at least one sliding board configured to slide along a plane within the interior volume of the housing; and at least one housing-attacher configured to fixedly couple the back of the housing to a planar surface. The two opposing sides of the housing may each comprise an opening such that the at least one sliding board is able to slide and extend outwardly from at least one of the opposing sides having the opening thereby revealing the sliding board, the face of which includes a sign, display, or message. In such a manner, a user may opt to pull from the housing the at least one sliding board to reveal the sign, display or message which other people may see.

According to another embodiment, a method of using the variable sign display system is also disclosed herein. The method of using the variable sign display system includes providing the variable sign display including a housing, at least one sliding board including a message; and at least one housing-attacher; attaching the housing to a planar surface via the at least one housing-attacher; pulling the at least one sliding board including the message outwardly from the housing to indicate information to at least one person.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a variable sign display system and method, constructed and operative according to the teachings of the present disclosure.

FIG. 1 is a perspective view of the variable sign display system during an ‘in-use’ condition, according to an embodiment of the disclosure.

FIG. 2 is a top view of a housing comprising a front plate and a rear plate, and a sliding message board of the variable sign display system of FIG. 1, according to an embodiment of the present disclosure.

FIG. 3 is a bottom view of the front plate and the rear plate of the housing, and the sliding message board of the variable sign display system of FIG. 1, according to an embodiment of the present disclosure.

FIG. 4A is a front view of the variable sign display system showing the sliding board comprising a message sliding to the left according to an embodiment of the present disclosure.

FIG. 4B is another front view of the variable sign display system showing the sliding board sliding to the right and revealing a different message according to an embodiment of the present disclosure.

FIG. 5 is a flow diagram illustrating a method of use for the variable sign display system, according to an embodiment of the present disclosure.

The various embodiments of the present invention will hereinafter be described in conjunction with the appended drawings, wherein like designations denote like elements.

### DETAILED DESCRIPTION

The present invention is directed to a two-way door sign. In one embodiment of the present invention, the two-way door sign may comprise a sign housing mountable to a door having a sliding message board contained within. Any suitable attaching means may be used for permanent or temporary securement.

Generally, sign housing may include a cavity for containing the sliding message board and fasteners for attaching the sign housing to a door. The message board may include a sliding message board body and at least two messages. The messages may include a readable word, number, phrase, or sentence. In the preferred embodiment, the message board may include two messages reading “Please Do Not Disturb” and “Please Make Up Room”. The messages may be printed, embossed, adhered, or otherwise attached to the message board body. The at least two messages may each be attached to the same face as each other, in such a way that they may be selected by merely sliding the message board along a plane parallel to the face on which the messages are attached.

The message board is retained within the cavity of the sign housing. The cavity is shaped such that the message board may be slid laterally within the cavity and may include two access windows at opposite ends of the sign housing for receiving the message board. Each of two ends of the sign housing may terminate in a tab with a countersunk aperture. Each aperture may receive a screw which is used to fasten the sign housing to a door. When the message board is slid laterally, one end of the message board protrudes from one of the two access windows in the sign board, thereby displaying the message on that end of the message board. In this way, a user may select a message to display. In the preferred embodiment, only one message may be displayed at a time. When one message protrudes from the display window, the alternative message is concealed within the cavity of the sign housing. If more than the two available messages are desired, the message board may be replaced by an additional unit bearing alternative messages. Alternate means for manipulation other than tabs may be used.

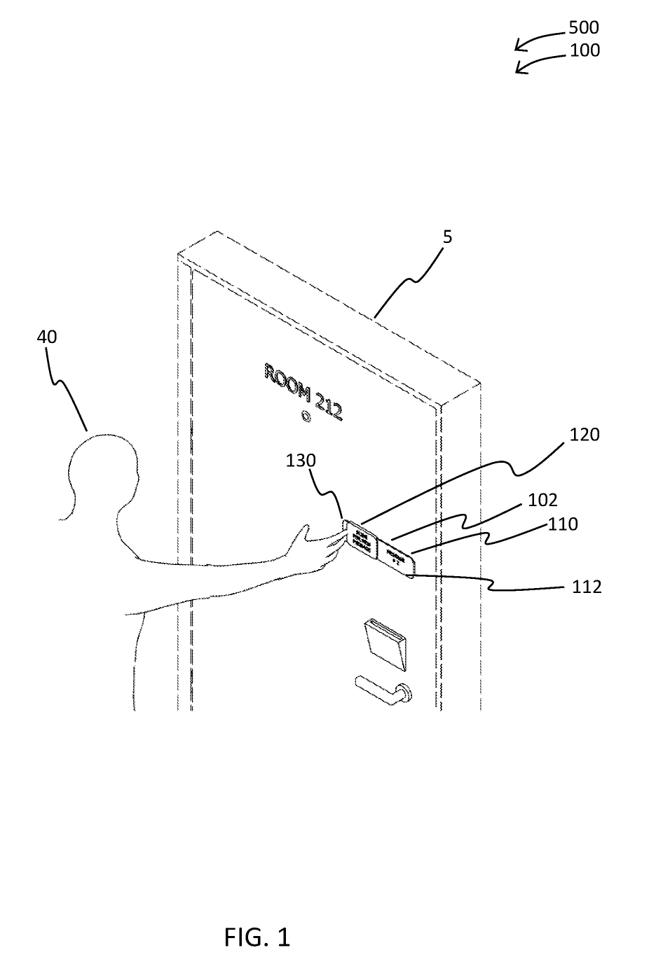

Referring now more specifically to the drawings by numerals of reference, there is shown in FIGS. 1-5, various views of a variable sign display 100 and method 500. FIG. 1 shows a variable sign display 100 during an ‘in-use’ condition 50, according to an embodiment of the present disclosure. Here, the variable sign display 100 may be beneficial for use by a user 40 to indicate a user preferred preference to other people by sliding a sliding board in one of two directions to reveal a message.

As illustrated in FIG. 1, the variable sign display 100 may comprise a housing assembly 102 including a front-plate 112, a back-plate 114, and at least one housing-attacher 116 configured to attach the back-plate 114 to a surface 5 (such as a door); the front-plate 112 and the back-plate 114 forming a housing 110 when coupled together; the housing 110 having two opposing openings defining an interior volume. The variable sign display 100 may further comprise a sliding board 120 defined by a face 122, a rear 124, a first-end 126, and a second-end 128, the sliding board 120 dimensioned to fit within the housing 110, the sliding board 120 configured to slide laterally across a plane 150 defined by the interior volume of the housing 110. The face 122 of the sliding board 120 comprises a first-display 130 and a second-display 140. During the ‘in-use’ condition 50, the variable sign display 100 is useful for conveying information pertaining to a preference of a user 40.

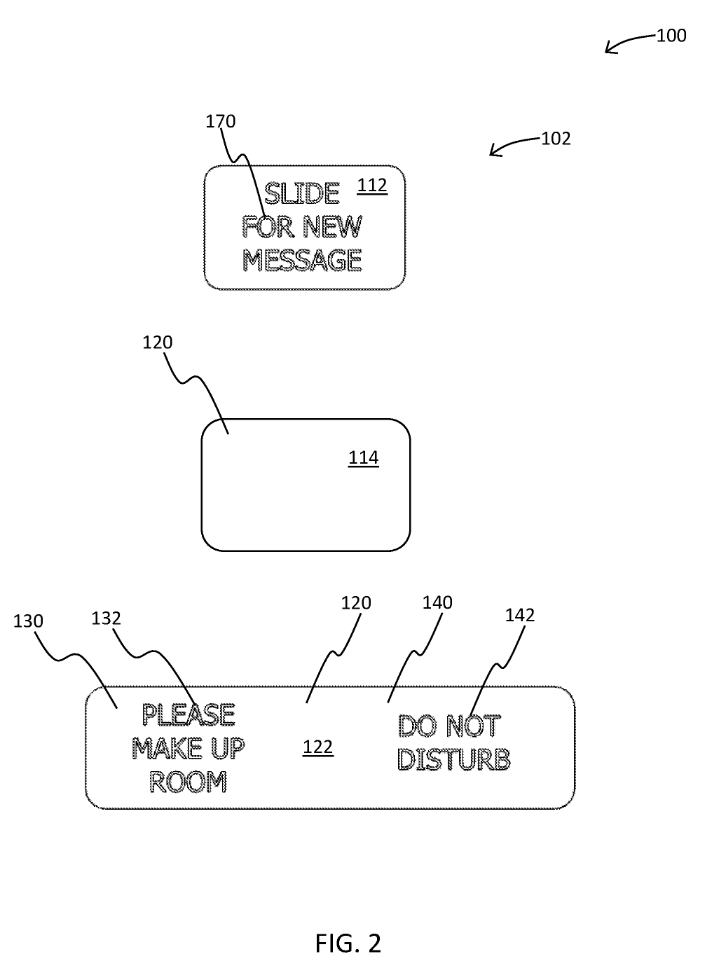

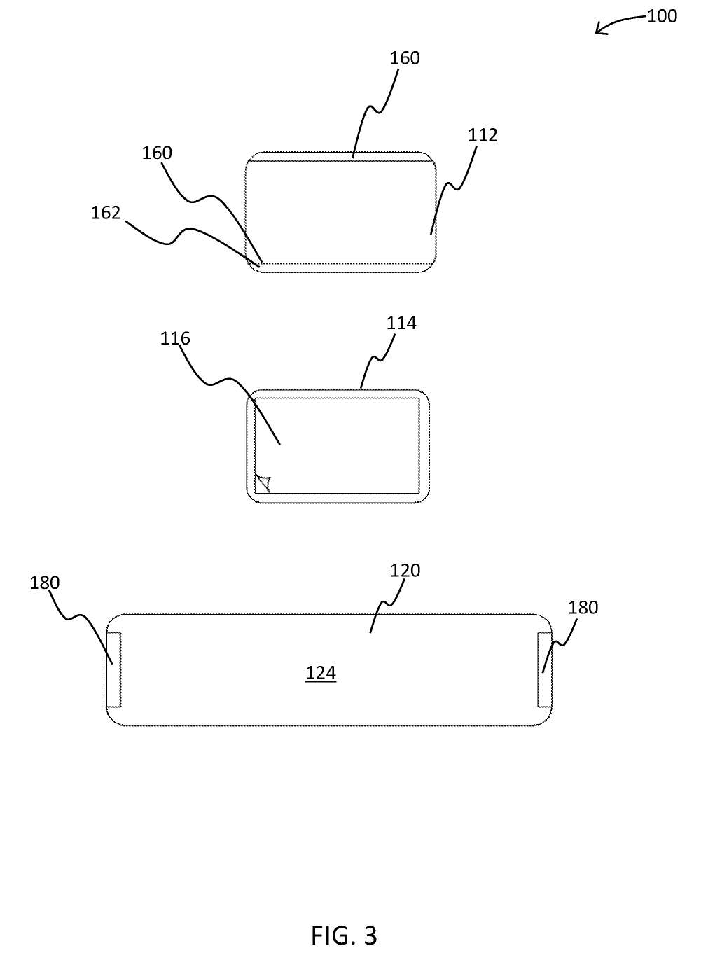

Referring now to FIGS. 2 and 3 showing a top view and a bottom view of the housing assembly 102 respectively. As above, the variable sign display 100 may include the housing assembly 102 and the sliding board 120. The housing assembly 102 may include the front-plate 112, the back-plate 114, and the at least one housing-attacher 116.

The front-plate 112, the back plate 114, and the sliding board 120 may generally comprise a rigid or semi-rigid construction (for example, metal, wood or plastic). The front-plate 112, the back-plate 114, and the sliding board 120 may further comprise a substantially rectangular profile. In one embodiment, the substantially rectangular profile may comprise rounded edges. As shown, the front-plate 112 and the back-plate 114 may comprise substantially similar dimensions such that they fit evenly together when coupled to form the housing 110. Further, as shown, the sliding board 120 is greater in length than the front-plate 112 and the back-plate 114 such that the sliding board 120 extends outwardly from at least one of the opposing openings of the housing 110. In one embodiment, the sliding board comprises 120 a dimensional length that is approximately double the length of the housing 110.

In referring to FIG. 2, an outer surface of the front-plate 112 may comprise instructional indicia 170 useful for conveying instructions of use to the user 40. The instructional indicia 170 may be configured to instruct the user 40 to slide the sliding board 120 to a left direction or to a right direction to visibly display either the first-display 130 or the second-display 140. In one embodiment, the instructional indicia 170 may read “SLIDE FOR NEW MESSAGE”, or the equivalent.

In continuing to FIG. 2, the face 122 of the sliding board 120 is shown comprising the first-display 130 and the second-display 140. As shown, the first-display 130 and the second-display 140 each occupy approximately half of a length of the face 122 of the sliding board 120. The first-display 130 may comprise a first-message 132 and the second-display 140 may comprise a second-message 142. In one embodiment, the first-message 132 may read “PLEASE MAKE UP ROOM” or the equivalent, and the second-message may ready “DO NOT DISTURB” or the equivalent. It should be noted and appreciated that the first-display 130 and the second-display 140 may display a wide variety of messages, signals, indicators, or notifications.

Referring now to FIG. 3, the at least one housing-attacher 116 may be affixed to a back-side of the back-plate 114 configured to couple the housing 110 to the surface 5. In one embodiment, the at least one housing-attacher 116 may comprise an adhesive element and a substrate covering the adhesive element, the adhesive element and the substrate coupled to the back-side of the back-plate 114, the substrate configured to peel off to expose the adhesive element, and the adhesive element configured to adhere the back-plate 114 of the housing 110 to the surface 5. In another embodiment, the at least one housing-attacher may comprise at least one mounting plate and at least one screw cooperatively configured to mount the back-side of the back-plate 114 of the housing 110 to the surface 5. Other attachment means, such as magnets, hook and loop fasteners, and the like, may also be employed in a similar manner.

In continuing to refer to FIG. 3, the rear 124 of the sliding board 120 may comprise at least one stop 180 located at the first-end 126 and another stop 180 at the second-end 128. As shown, the stop 180 may essentially comprise a wall protruding vertically upward from the rear 124 of the sliding board 120. The stop is configured to prevent the sliding board 120 from escaping the interior volume of the housing 110. In such a manner, the user 40 is unable to completely pull the sliding board 120 out from the housing 110 because the stop 180 prevents the sliding board 120 from passing through one of the opposing openings of the housing 110. Further, the stop 180 may act as a handle or pull-tab providing a grippable surface for the user 40 when sliding laterally in either direction across the plane 50.

In continuing to refer to FIG. 3, a bottom of the front-plate 112 may comprise a track 160. The track 160 may be configured to guide the sliding board 120 during lateral movement in either direction across the plane 50. Further, a peak 162 of the track 160 may be affixable to a top-surface of the back-plate 114 which forms the housing 110. In another embodiment, the track 160 may comprise a pair of parallel tracks spanning a height of the back-plate 114 of the housing 110, the parallel tracks useful for guiding the sliding board 120 during lateral movement, and further configured to provide support structure to the housing 110.

According to one embodiment, the variable sign display 100 may be arranged as a kit 105. The kit may include packaging comprising the housing assembly 102 (including the front-plate 112, the back-plate 114, and the at least one housing-attacher 116), the sliding board 120, and a set of user instructions. The instructions may detail functional relationships in relation to the structure of the variable sign display 100 such that the variable sign display 100 can be used, maintained, or the like, in a preferred manner. Further, it should be appreciated that the kit 105 may include sliding board(s) 120 displaying a variety of messages based on consumer need.

In one embodiment of the variable sign display 100 as shown in FIGS. 1-3, the housing 110 comprises a substantially rectangular profile having rounded edges. It should be noted and appreciated that the housing 110 may comprise other shapes and profiles, such as a square profile, an oval profile, an elliptical profile, a circle profile, a triangular profile, and the like.

Further, it should be noted that the front-plate 112 of the housing 110 may be opaque thereby concealing a portion of the sliding board 120 that is positioned within the interior volume of the housing 110. In other embodiments, the front-plate 112 of the housing 110 may be transparent, translucent, or semi-opaque.

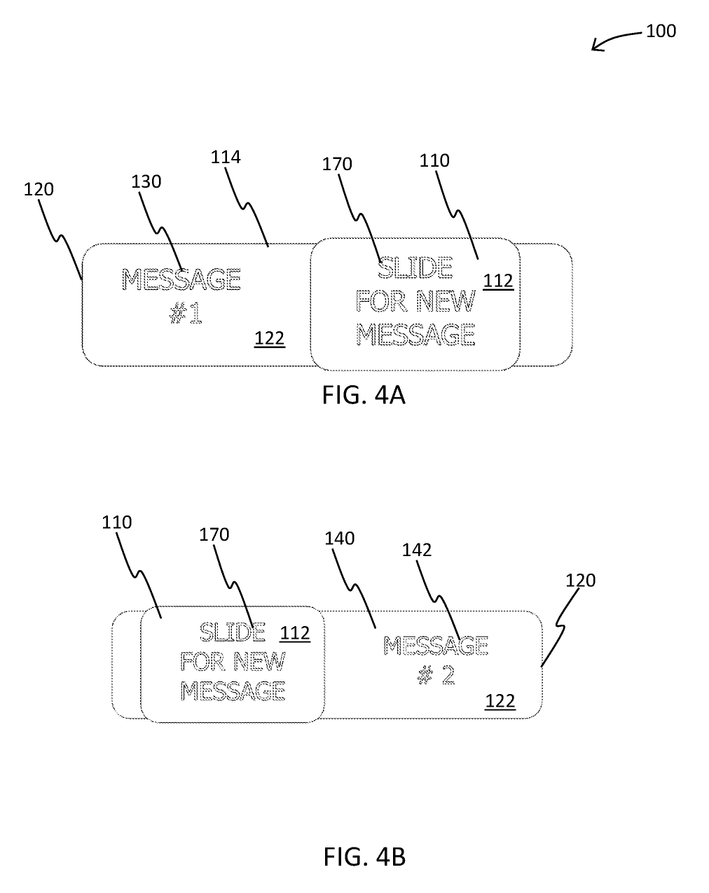

In referring to FIGS. 4A and 4B, it may be seen that the sliding board 120 may comprise the first-display 130 and the second-display 140. In one embodiment, the first-display 130 and the second-display 140 may comprise a sign. As shown, the sliding board 120 may comprise the first-display 130 comprising the first-message 132 and the second-display 140 comprising the second-message 142. As shown in FIG. 4A, the sliding board 120 may comprise the first-message 132 reading “PLEASE MAKE UP ROOM” which may be visible when the display board 120 is pulled to the left. As shown in FIG. 4B, the sliding board 120 may comprise the second-message 142 reading “DO NOT DISTURB” which may be visible when the display board 120 is pulled to the right.

It should be noted that any particular message may be displayed on the display board 120. Some examples may include: “VACANCY” and “NO VACANCY”; “OPEN” or “CLOSED”; “OCCUPIED” or “UNOCCUPIED”; and the like. It should further be noted that while a great use of the variable sign display 100 would be for hotel rooms, other uses for residential and commercial doors, bathrooms, windows, elevators, stairwells, and the like. Further, the first-display 130 and the second-display 140 may comprise other indicia conveying a similar meaning of the message. Furthermore, the first-display 130 and the second-display 140 may be displayed in a variety of languages for use of the variable sign display 100 in various countries.

A preferred embodiment of the variable sign display 100 is disclosed herein. The variable sign display 100 may comprise a housing 110 having a substantially 3D rectangular profile, the housing 110 defined by a front 112, a back 114, left-side 116, a right-side 116, a top, a bottom, and an interior volume 118; a sliding track 124 traversing a plane 122 from the left-side and the right-side of the housing 110 within the interior volume 118; a sliding board 120 having a length and a mid-point, the sliding board 120 configured to slide along the sliding track 124, the sliding board 120 divided in half at the mid-point of the length into a left-segment and a right-segment, the left-segment and the right-segment each having a message; a left-pull-tab connected to the left-segment of the sliding board 120; a right-pull-tab connected to the right-segment of the sliding board 120; and at least one housing-attacher 130 configured to fixedly couple the back 114 of the housing 110 to the door 10. The left-side and the right-side of the housing 110 each comprises an opening 140 for allowing egress and ingress of the sliding board 120. The front 112 of the housing 110 is opaque concealing the display 160 when the sliding board 120 is wholly positioned within the interior volume 118 of the housing 110. During use, a face of sliding board 120 comprises at least two displays 160 useful for conveying information according to a preference of a user 40. Further, the sliding board 120 may comprise at least two semi-rigid side walls 128 configured to enable the user 40 to push the sliding board 120.

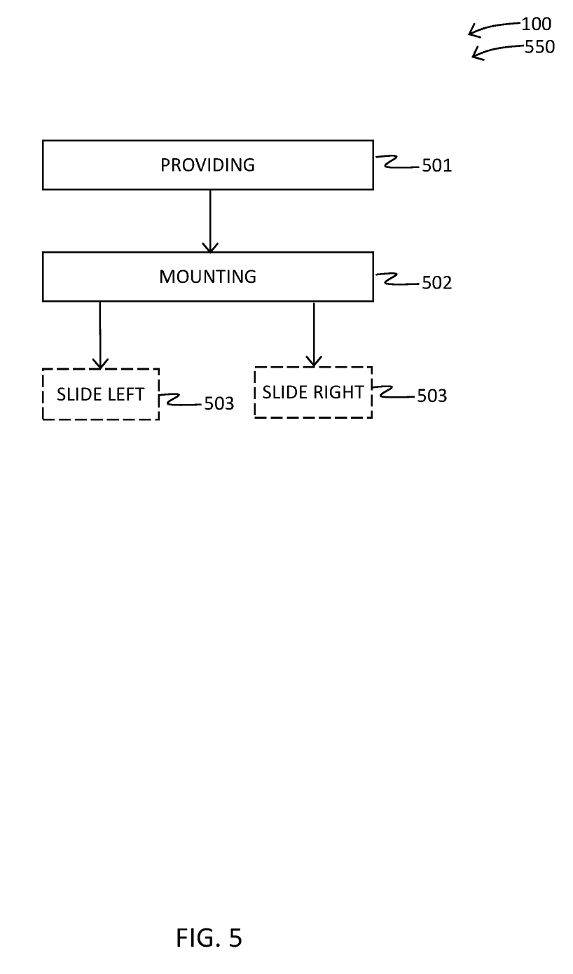

FIG. 5 is a flow diagram 550 illustrating a method of use 500 for the variable sign display 100, according to an embodiment of the present disclosure. In particular, the method of use 500 for the variable sign display 100 include the steps of: step one 501, providing the variable sign display 100 including a housing assembly 102 comprising a front-plate 112 and a back-plate 114 (forming the housing 110 when coupled together), a housing-attacher 116, and at least one sliding board 120 comprising a first-display 130 and a second-display 140; step two 502, attaching the back-plate 114 of the housing 110 to a surface 5 via the at least one housing-attacher 116; and step three 503, sliding the sliding board 120 to a left direction to reveal the first-message 130 or sliding the sliding board 120 to a right direction to reveal the second-message 140 based on user preference.

It should be noted that step 503 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for displaying a choice of two messages via a door sign.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A variable sign display, the variable sign display comprising:
a housing assembly including a front-plate, a back-plate, and at least one housing-attacher configured to attach the back-plate to a surface; the front-plate and the back-plate forming a housing when coupled together; the housing having two opposing openings defining an interior volume; and
a sliding board defined by a face, a rear, a first-end, and a second-end, the sliding board dimensioned to fit within the housing, the sliding board configured to slide laterally across a plane defined by the interior volume of the housing;
wherein the sliding board comprises a greater dimensional length than the housing such that the sliding board extends outwardly from at least one of the opposing openings of the housing; and
wherein the face of the sliding board comprises a first-display and a second-display.

2. The variable sign display of claim 1 wherein the rear of the sliding board comprises a stop at the first-end and the second-end.

3. The variable sign display of claim 2 wherein the stop is configured to prevent the sliding board from escaping the interior volume of the housing.

4. The variable sign display of claim 3 wherein an inner surface of the rear-plate comprises a track.

5. The variable sign display of claim 4 wherein the track is configured to guide the sliding board during lateral movement.

6. The variable sign display of claim 5 wherein a peak of the track is affixable to a bottom-surface of the front-plate.

7. The variable sign display of claim 6, wherein the front-plate of the housing is opaque.

8. The variable sign display of claim 7, wherein the sliding board is configured such that the first-display is wholly visible when the second-display is wholly concealed by the front-plate of the housing, and alternatively, the second-display is wholly visible when the first-display is wholly concealed by the front-plate of the housing.

9. The variable sign display of claim 8, wherein the front-plate of the housing comprises instructional indicia.

10. The variable sign display of claim 9, wherein the instructional indicia are configured to instruct a user to slide the sliding board to a left direction or to a right direction to visibly display either the first-display or the second-display respectively.

11. The variable sign display of claim 9, wherein the first-display comprises a first-message and alternatively a first-sign.

12. The variable sign display of claim 9, wherein the second-display comprises a second-message and alternatively a second-sign.

13. The variable sign display of claim 9, wherein the at least one housing-attacher comprises an adhesive element and a substrate covering the adhesive element, the adhesive element and the substrate coupled to a back-side of the back-plate, the substrate configured to peel off to expose the adhesive element, and the adhesive element configured to adhere the back-plate of the housing to the surface.

14. The variable sign display of claim 9, wherein the at least one housing-attacher comprises at least one mounting plate and at least one screw cooperatively configured to mount a back-side of the back-plate of the housing to the surface.

15. The variable sign display of claim 9, wherein the front-plate, the back-plate, and the sliding board each substantially comprise a rectangular profile.

16. The variable sign display of claim 15, wherein the front-plate, the back-plate, and the sliding board each substantially comprise a rectangular profile with rounded corners.

17. The variable sign display of claim 1, wherein the surface comprises a door.

18. A variable sign display for a door, the two-way sign display comprising:
a housing assembly including a front-plate having a substantially rectangular profile, a back-plate having the substantially rectangular profile, and at least one housing-attacher configured to attach the back-plate to a surface; the front-plate and the back-plate forming a housing when coupled together; the housing having two opposing openings defining an interior volume; and
a sliding board having the substantially rectangular profile defined by a face, a rear, a first-end, and a second-end, the sliding board dimensioned to fit within the housing, the sliding board configured to slide laterally across a plane defined by the interior volume of the housing;
wherein the sliding board comprises a dimensional length that is approximately double a length of the housing such that the sliding board extends outwardly from at least one of the opposing openings of the housing;
wherein the rear of the sliding board comprises a stop at the first-end and the second-end, the stop configured to prevent the sliding board from escaping the interior volume of the housing;
wherein an inner surface of the back-plate comprises a track, the track configured to guide the sliding board during lateral movement;
wherein the face of the sliding board includes a first-display comprising a first-message and a second-display comprising a second-message;
wherein the front-plate of the housing comprises instructional indicia configured to instruct a user to slide the sliding board to a left direction or to a right direction to visibly display either the first-display or the second-display respectively; and
wherein the sliding board is configured such that the first-message is wholly visible when the second-message is wholly concealed by the front-plate of the housing, and alternatively, the second-message is wholly visible when the first-message is wholly concealed by the front-plate of the housing.

19. The variable sign display of claim 18 further comprising a set of instructions; and
wherein the variable sign display is arranged as a kit.

20. A variable sign display, the method comprising the steps of:
providing the variable sign display including a housing assembly having a front-plate, a back-plate, and at least one housing-attacher, and a sliding board having a first-display and a second-display;
mounting the back-plate of the housing assembly to a surface via the at least one housing-attacher; and
sliding the sliding board in a left direction to display a first-display or sliding the board in a right direction to display a second-display according to user preference.
